(19) United States
(12) Patent Application Publication
(10) Pub. No.: US 2022/0198446 A1
(43) Pub. Date: Jun. 23, 2022

(54) Method for Recording Data Related to Product Manufacture and Sales, and Related System

(71) Applicants: Aleksey Vladislavovich POTANIN, Saint-Petersburg (RU); Victor Vladimirovich VERNIKOVSKY, Moscow (RU)

(72) Inventors: Aleksey Vladislavovich POTANIN, Saint-Petersburg (RU); Victor Vladimirovich VERNIKOVSKY, Moscow (RU)

(21) Appl. No.: 17/602,213

(22) PCT Filed: Apr. 6, 2020
(86) PCT No.: PCT/RU2020/050069

§ 371 Date: Oct. 7, 2021

(30) Foreign Application Priority Data
Apr. 11, 2019 (RU) 2019 110877

(51) Int. Cl. G06Q 20/38; G06Q 20/40; G06Q 10/08; H04L 9/06

(52) U.S. Cl. CPC G06Q 20/389; G06Q 20/401; H04L 2209/38; H04L 9/0643; G06Q 10/087

(57) ABSTRACT

A method of recording data, wherein the method includes recording data related to manufacture and sales of products in one or more enterprise management information systems at a rate at which production cycles are completed; deriving, from the recorded data, data in accordance with requirements of industry standards used in an enterprise, and generating artifacts based on the derived data; generating key attributes which briefly describe the generated artifacts; transmitting the generated artifacts and the key attributes to a logic module; transmitting the generated artifacts to an interplanetary file system (IPFS) node for recording in the IPFS; generating, by the node, a hash for each recorded artifact, which unambiguously identifies the recorded artifact, and transmitting generated hashes to the logic module; combining, by the logic module, each generated hash with respective key attributes; and transmitting the combined result to a blockchain platform node to be recorded in the blockchain platform.

### CROSS-REFERENCE TO RELATED APPLICATIONS

The present application is the U.S. National Phase of PCT/RU2020/050069, filed on 6 Apr. 2020, which claims priority to Russian Patent Application No. 2019110877, filed on 11 Apr. 2019, the entire content of which are incorporated herein by reference.

### BACKGROUND

### Field

The present invention relates to the field of information systems, in particular, to a method and system for automatic recording of data related to product manufacture and sales based on a blockchain platform.

### Related Art

Certification of production is a specific composite complex process which includes comprehensive audit of a manufacturing enterprise and reorganization of internal processes according to the requirements of a standard. Certification is carried out by authorized agencies which confirm that processes and standards of a manufacturing enterprise meet the requirements of a standard. After certification of a manufacturing enterprise it is entitled to issue certificates according to a predetermined standard, i.e., documents which confirm that a product has been manufactured in accordance with the predefined standards. After that, in order to confirm that the requirements of this standard are met, periodic audit of processes and standards of the manufacturing enterprise is performed, after which the term of entitlement for issuing certificates for the standard is extended, i.e., it is confirmed that processes of the manufacturing enterprise meet the requirements of the standards for the period of extension.

Present-day development of information technologies enables digitizing data on all operations carried out at an enterprise at all stages of manufacturing of a given product, which may be accessed to check the validity of issued certificates, and would also facilitate carrying out the certification of the enterprise by authorized agencies. For example, a prior art solution is disclosed in document US 2018130034 A1 (“Extended blockchains for event tracking and management”), which describes systems and methods for providing secure supply chains for labeled products. According to this prior art solution, a blockchain—a distributed connected chain of blocks including information—may record data on a new manufactured product which, e.g., is labeled with a time stamp having a unique identifier and non-changeable product data (e.g., batch number, expiry date, etc.). Transactions for recording in the blockchain may be formed both on the manufacture-related side and on product distribution and/or consumer side, wherein the transaction may determine the product transfer from one user to another. According to this solution, each side may be provided with its own digital node for accessing the blockchain, wherein each node may be provided with a different set of capabilities, e.g., end user may have less capabilities as compared to users that are related to manufacture, distribution, and/or dispensing of the product. However, this solution has a problem that the blockchain is not designed for storing large amounts of data and large files. Besides, this solution does not consider storing transactions in accordance with requirements of one or more industry standards which govern the manufacture, to facilitate further certification of the manufacture and real-time monitoring by providing comparable information for various enterprises of an industry.

Prior art solution is also disclosed in document RU 2639015 C1 (“Method of product authenticity and quality control in a manufacturing and sales process”), which also uses the blockchain technology, providing for storing information on each product manufacturing operation in a distributed database, wherein a new segment is added in the chain of the distributed database, which segment stores data on the time, date, participants, type of operation, and information on the whole distributed information storage and processing system, all parts of which are continuously synchronized with respect to the general status of its operations in order to maintain information integrity and validity. This solution provides for making changes, as well as product quality and authenticity control by all participants of the technological cycle of product manufacture and sales (both by manufacturers and end users). However, this solution also has a problem that blockchain is not designed for storing large amounts of data and large files. Besides, storage of transactions in accordance with the requirements of one or more industry standards used in a manufacturing entity to facilitate further certification of manufacture and real-time monitoring by providing comparable information for various enterprises of an industry is also not taken into consideration in this solution.

A solution disclosed in document US 2018285810 A1 (“Systems and methods of blockchain transaction recordation in a food supply chain”) is regarded as a prototype of the claimed invention, which solution is directed to a method for recording data in a food products supply chain system, wherein this solution uses identifiers, which are a set of key pairs used to enter transactions into a blockchain on behalf of a user or an enterprise. User accounts may be, e.g., accounts for a seed manufacturer, a farmer, a logistics operator, a cooperative, a restaurant, a grocer, or any other participant of a production and supply chain. Multiple data types may be recorded in a blockchain, such as: data acquired in real time (e.g., ambient temperature according to a sensor, ambient humidity according to a sensor, etc.), manually input information (e.g., genome information, seed information, farmer, and/or farming techniques, etc.) and/or encrypted information (e.g., on a food cooking process), etc. Besides, according to this solution, data may be stored in nodes of a blockchain network already in an encrypted form, and, when there are large amounts of information to be stored, the blockchain stores a file signature and a link to an external information source (e.g., IPFS catalogue), which stores the file per se. However, storing transactions in accordance with the requirements of one or more industry standards used in a manufacturing entity to facilitate further certification of manufacture and real-time monitoring by providing comparable information for various enterprises of an industry is also not taken into consideration in this solution.

Thus, it is necessary to provide an alternative system for recording data related to manufacture and sales of products to facilitate further certification of manufacture and generation of certificates for products, which attends to the need for storing large amounts of data, and records data in accordance with requirements of one or more industry standards used in a manufacturing entity, which would make it impossible for mala fide suppliers to adulterate product certificates.

Technical problem to be solved by the present invention consists in broadening the scope of means for recording manufacturing data.

### SUMMARY OF INVENTION

### Technical Problem

The problem set forth above is resolved by using the inventive method for recording data related to manufacture and sales of products, and a respective system, which automatically generate artifacts related to requirements of standards, based on which certificates are generated.

### Solution to Problem

According to one aspect, a method of recording data related to manufacture and sales of products is provided, the method including:
recording data related to manufacture and sales of products in one or more enterprise management information systems at a rate at which production cycles are completed;
deriving, from the recorded data, data in accordance with requirements of industry standards used in the enterprise, and generating artifacts on the basis of the derived data;
generating key attributes which briefly describe the generated artifacts;
transmitting the generated artifacts and key attributes to a logic module;
transmitting the generated artifacts to a node of an interplanetary file system (IPFS) for recording in the IPFS file system;
generating, by the IPFS node, a hash for each recorded artifact, which unambiguously identifies the respective recorded artifact, and transmitting the generated hashes to the logic module;
combining, by the logic module, each generated hash with respective key attributes; and
transmitting the results of the combination to a blockchain platform node to be recorded in the blockchain platform.

According to the second aspect, a system for recording data related to manufacture and sales of products is provided, which includes a plurality of nodes deployed in each enterprise which participates in the process of manufacture and sales of products, each node including:
one or more enterprise management information systems configured to record data related to the manufacture and sales of products at a rate at which production cycles are completed;
a node monitoring unit configured to derive, from the data recorded to one or more enterprise management information systems, data in accordance with requirements of industry standards used in the enterprise, and generate artifacts on the basis of the derived data, and key attributes which briefly describe the generated artifacts;
a logic module configured to receive the generated artifacts and key attributes from the node monitoring unit;
an interplanetary file system (IPFS) node configured to receive the generated artifacts obtained from the logic module for recording in the IPFS file system and generating a hash for each recorded artifact, which unambiguously identifies the respective recorded artifact, and transmit the generated hashes to the logic module, wherein the logic module is further configured to combine each generated hash with respective key attributes; and
a blockchain platform node configured to receive the combination result to be recorded in the blockchain platform.

### Advantageous Effects of Invention

Technical result achieved by using the present group of inventions consists in enabling the record of large amounts of data related to a given manufacture by means of a blockchain technology in accordance with one or more industry standards used in the enterprise.

### BRIEF DESCRIPTION OF DRAWINGS

These and other features and advantages of the present group of inventions will become apparent after reading the specification provided hereinbelow and referring to the accompanying drawings, in which:

FIG. 1 is a general block diagram of a node of a system for recording data related to the manufacture and sales of products, in accordance with one embodiment of the present invention;

FIG. 2 illustrates a process of generating artifacts in the course of production process in accordance with one embodiment of the present invention; and

FIG. 3 is a detailed block diagram of a node of the system for recording data related to the manufacture and sales of products, in accordance with one embodiment of the present invention.

### DETAILED DESCRIPTION

Different embodiments of the present invention are described hereinbelow in more detail with reference to the drawings. However, the present invention may be embodied in many other forms and should not be construed as being restricted by any specific structure or function provided in the following description. Based on the present specification, a person skilled in the art will understand that the scope of protection of the present invention covers any embodiment of the present invention disclosed herein regardless of whether it is implemented individually or in a combination with any other implementation of the present invention.

Audit of a manufacturing enterprise includes an analysis of many various data related to the manufacture. The claimed invention suggests collecting and recording all data during the manufacture of products, which are obtained in the course of manufacturing the products, wherein the invention suggests recording the data in a distributed manner using a blockchain technology to provide for data integrity and authenticity. Data generated in the manufacturing process may include detailed description of specificities of the production technology, description of raw materials being used, amount of production, date and time of manufacture of the product, data on the recipient of the product, data on personnel who participate in the manufacture of the product, data related to specific standards used in the enterprise (GOST, TUF . . .), etc. Generally, the amount of data does not have any technological or other limits and is only restricted to the amount which the manufacturing enterprises per se are ready to submit to the blockchain platform, or by the organizational structure of the platform approved by all participants of the process of manufacture and sales of products (in other words, all enterprises which are related to the circulation of products). Main requirement to the amount of recorded data which are related to manufacturing processes (their content and type) is that there should be data required for performing the certification of the enterprise and generating a product certificate. Therefore, both data related to certification standards and other manufacturing data may be stored in a blockchain platform.

Since the size of data blocks stored in a blockchain is critical for most blockchain platforms and has intrinsic restrictions, the present invention suggests initially placing all data related to the manufacture of products in an IPFS file system (interplanetary file system). IPFS file system is a decentralized file exchange network which makes use of a content-addressable, peer-to-peer hypermedia communication protocol, the nodes of said network forming a distributed file system. When data are placed in the IPFS file system, this file system provides a hash for the placed data, which unambiguously identifies said data placed in the file system. The present invention suggests storing the provided hash in a blockchain platform together with pointers which further allow to quickly find the necessary hash to perform an operation of extracting the data placed in the IPFS file system. On one hand, such placement of data enables supporting an independent data storage without restrictions to the amount of stored information and, on the other hand, it regulates the size of blocks in the blockchain platform and prevents them from expanding and causing untimely system degradation.

However, there is still a problem with such placement of data, which is related to further certification on the basis of the stored data being quite problematic, since data of the same type may be differently stored or named, which makes it difficult to compare the data. The claimed invention further suggests first placing the data into enterprise management information systems, such as an enterprise resource planning (ERP) system, manufacturing execution system (MES), supervisory control and data acquisition (SCADA) system, electronic document management system (EDMS), etc., in accordance with the requirements of one or more industry standards used in the enterprise, at a rate at which production cycles are completed (substantially in real time), generate corresponding artifacts broken down according to the requirements of industry standards, and only then placing the generated artifacts in the IPFS file system as aforementioned. Nature and type of the generated artifacts is defined by requirements of industry standards, which makes it possible to store comparable information for different enterprises within an industry in the file system. Certificate which confirms the quality of products may then be generated basing on data stored in the IPFS file system by accessing the respective hash stored in the blockchain platform by means of appropriate software. In the context of the present document, generated certificate for a product shall be understood as digital certificate for the product. Digital certificate contains all particulars of standard “paper” certificates, besides it also contains numbers of production tasks to enable the extraction of data blocks with these production tasks as will be described in more detail hereinbelow. Use of standards as a reference point and recording results of operation of enterprises related to the manufacture and sales of products in a data recording system provides transparency both to the generation of certificates per se and the manufacturing processes used for the manufacture of certified products.

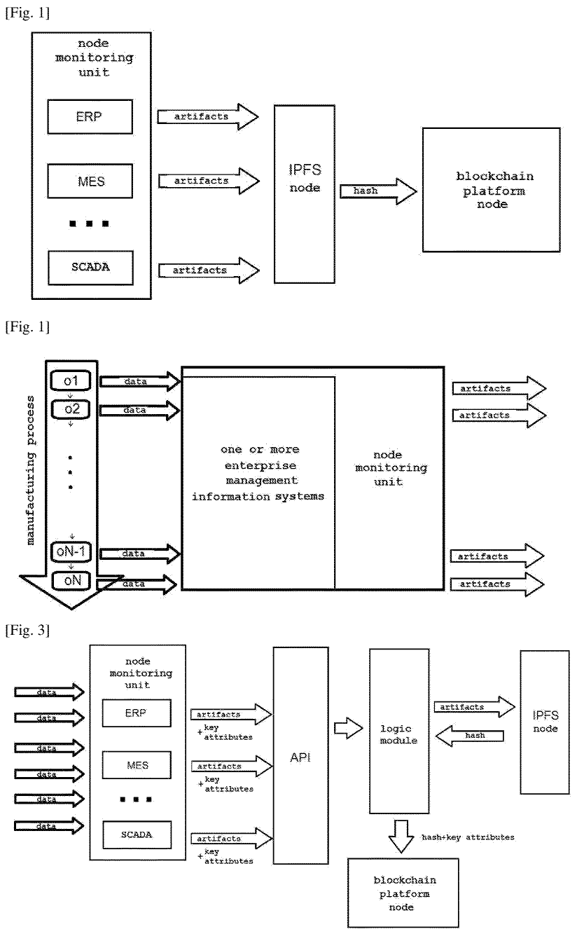

FIG. 1 is a general block diagram of a node of a system for recording data related to the manufacture and sales of products in accordance with one embodiment of the present invention. In particular, the claimed system for recording data related to the manufacture and sales of products includes a plurality of nodes which are connected to each other and form a peer-to-peer network. Each node is located in a respective enterprise which participates in the process of manufacture and sales of products and includes a blockchain platform node, an IPFS file system node, as well as one or more enterprise management information systems. Optionally, a blockchain platform node and IPFS file system node are integrated with one or more enterprise information systems, wherein the blockchain platform node has its own copy of the whole database of the blockchain platform, and the IPFS file system node has its own copy of the whole database of IPFS file system. Thus, each participant of the process of manufacture and sales of products (in particular, all participants of the market that produce added value and generate records for the blockchain platform) should have its own full-scale node, as mentioned above, wherein end users of products or respective supervising/certifying agencies may be provided access to the blockchain platform and IPFS file system to obtain initial data on certificates, perform certification, check authenticity, etc. For example, supervising/certifying agencies are enabled to conduct audit regarding the fulfillment of requirements of standards substantially in real time and for each operation of manufacture and sales of products. To implement this approach, applied standards are adapted for their organic (so to say, “seamless”) integration into enterprise management information systems, since present-day certification standards are aimed at using conventional “paper” technologies and not adapted to be used in digital form, i.e., applied standards should be converted into computer-readable form. Besides, the enterprise management information systems per se should also be adapted to support standardization, in particular, each node of the system for recording data related to the manufacture and sales of products should be provided with a node monitoring unit operatively connected to each enterprise management information system of the node of the system and configured to analyze all data recorded in one or more enterprise management information systems and extract, from these data, the data which correspond to the requirements of industry standards used in the enterprise (data related to processes of generating certificates or related thereto), and to generate artifacts based on the extracted data. Optionally, the node monitoring unit is configured to generate additional artifacts related to general data which are not required in accordance with industry standards. These additional artifacts may also be recorded in the IPFS file system node for further storing their hash in the blockchain platform node.

Besides, the node monitoring unit is further configured to further record the generated artifacts in the IPFS file system, in particular, configured to transmit said generated artifacts to respective IPFS file system node for recording them in the IPFS file system.

FIG. 2 describes the process of generating artifacts in the course of manufacturing process in accordance with one embodiment of the present invention. This Figure shows a manufacturing process which consists of a series of sequential manufacturing operations o1, o2 . . . oN-1, oN. Material flow is input in the manufacturing process, which flow is correspondingly processed in each manufacturing operation. As a result of each manufacturing operation, a sort of intermediate product is generated, wherein end product is generated in the end of manufacturing process after completion of all manufacturing operations. All manufacturing operations should meet the certification requirements, i.e., industry standards for this product, which is reflected, in particular, in respective data related to these operations and corresponding intermediate products. As a result of each operation of the manufacturing process, such data related to this operation and corresponding intermediate product are recorded in one or more enterprise management information systems. Node monitoring unit analyzes all data recorded in the one or more enterprise management information systems and extracts, from these recorded data, data in accordance with the requirement of industry standards used in the enterprise to generate respective artifacts, access to which makes it possible to unambiguously determine that all operations were performed in accordance with the requirements of the standards. Then the generated artifacts are transmitted for recording to the IPFS file system as described above. Thus, as graphically shown in FIG. 2, different manufacturing data are stored at a rate of completion of production cycles in one or more enterprise management information systems, then data are extracted in accordance with the requirements of one or more industry standards used in the enterprise, based on which respective artifacts are recorded, being broken down according to the requirements of industry standards, to be placed in the IPFS file system via the respective IPFS file system node, which provides a hash and key attributes for their placing in the blockchain platform, which will be described in more detail below. Optionally, in addition to data extracted in accordance with the requirements of one or more industry standards used in the enterprise, general manufacturing data are also extracted, i.e., additional artifacts which are also to be placed in the IPFS file system via the respective node of the IPFS file system that provides a respective hash and key attributes for their placing in the blockchain platform.

Therefore, according to the claimed invention, all operations of an enterprise for manufacturing, production and sales of products in accordance with specific standards are recorded in corresponding enterprise management information systems. Storage of all recorded artifacts in the IPFS file system with subsequent transmission of the hash in the blockchain platform in real time ensures inalterability of the stored artifacts. Thus, authenticity of a certificate for a product generated by an enterprise based on artifacts stored in an IPFS file system and a blockchain platform (i.e., stored in the IPFS file system, wherein these artifacts are accessed by accessing respective hashes stored in the blockchain platform) and, therefore, of all data provided in the certificate, can be obviously and quickly checked based on the chain of blocks of the blockchain platform which are stored in the course of manufacturing of this product. Since all participants of the process of manufacture and sales of products participate in storing the artifacts, chain of manufacture may be traced from the end product and up to its initial components (raw materials, materials, parts, storage conditions, manufacturing process conditions, etc.). Enterprises which generate a certificate to an end product may also include, in this generated certificate, certificates generated by other participants of manufacture and sales of the products in respect of the intermediate products used in said end product.

Regarding the process of generating a product certificate using the above-mentioned system for recording data related to manufacture and sales of products, the following may be noted. Product certificate is issued for a ready product and is characterized, in particular, by product name, batch size, contractor, set of product properties, etc. In its turn, manufacturing process consists of the following components: manufacturing technology, technological charts and/or progress charts, specifications for initial components, properties of initial components, personnel and labor efforts, standards, protocol and/or procedure of placing an order, test and/or laboratory measurement data, time parameters and technology restrictions, etc. As mentioned above, the set of manufacturing process components is not limited in any way, the main requirement being availability of data needed for performing further certification/generating a product certificate. Each enterprise that participates in the process of manufacture and sales of products has its own process of manufacture, and thus enterprise management information systems of each enterprise participating in the process of manufacture and sales of products generate their own artifacts for storing in IPFS file system as technological processes are performed at a rate of manufacturing cycles completion. Optionally, all generated artifacts may be recorded in the IPFS file system in encrypted form using private keys of participating enterprises, wherein it is necessary to obtain an appropriate public key to read data from the system. Blocks which contain hashes provided by the IPFS file system and recorded in the blockchain platform are closed in the blockchain platform in accordance with the confirmation mechanism being used (consensus mechanism or a different one depending on the platform). In general, technologies of manufacturing products in enterprises may be significantly different even for the same products, but using standards as a unified reference common for all enterprises of an industry makes it possible to store and process comparable data, which enables real comparison between products.

Recording data with the system for recording data related to the manufacture and sales of products may be started, e.g., with the start of production task. From the time of start of the production task, all technological operations, materials, working conditions, intermediate results of operations, intermediate products are recorded in one or more enterprise management information systems. Then, node monitoring unit which is operatively coupled to them generates respective artifacts/additional artifacts to be stored in a corresponding IPFS file system node, which is configured to provide a hash to be placed in a respective node of the blockchain platform. According to this embodiment, all transactions are recorded being broken down by production tasks. After a production task is completed, production task number may be encoded and also recorded in a blockchain platform node, wherein the recorded number will be connected to the certificate which will be generated for the manufactured product.

As aforementioned, different users may be granted access to the blockchain platform, wherein each user is granted their individual access levels. In particular, individual access level for end users and supervising/certifying agencies preferably includes a read-only access without a possibility for making any corrections or modifications. These users access the blockchain platform (and, thus, the IPFS file system) through client applications intended for providing information on product certificate and artifacts related thereto, recorded in the IPFS file system. Individual access level for enterprises participating in the process of manufacture and sales of products includes complete access, i.e., these enterprises may modify the blockchain platform by recording new artifacts in respective nodes of the IPFS file system, which, in its turn, would provide a hash to be stored in respective nodes of the blockchain platform. Enterprises which participate in the process of manufacture and sales of products may also perform access only for viewing the recorded data chains or requesting the blockchain platform to generate a respective certificate for products based on data recorded in the IPFS file system and the blockchain platform. Request for generating the necessary certificates for products may be generated by means of appropriate software which is loaded directly from the blockchain platform, in particular, by means of an appropriate application.

In one embodiment, program interfaces designed for realizing interaction between one or more enterprise management information systems (and the node monitoring unit) and the IPFS file system node and/or blockchain platform node are implemented as M2M type interfaces, which enable the above-mentioned systems to interact with each other directly. In particular, REST API interface is one of the most widespread and versatile interfaces of such type, however, any other type of interface may be also used provided that it corresponds to the operation logic of the system.

In particular, FIG. 3 shows a detailed block diagram of a node of a system for recording data related to manufacture and sales of products in accordance with one embodiment of this invention, which shows the details of interaction between the units of the above-mentioned system node. In particular, this Figure shows the input of all manufacturing data to one or more enterprise management information systems, which data are analyzed by the node monitoring unit to generate respective artifacts and, optionally, additional artifacts as disclosed in detail above. The node monitoring unit also generates key attributes which briefly describe the respective generated artifacts. Besides, the system for recording data related to manufacture and sales of products being currently discussed includes a logic module configured to implement the operation logic of the discussed system. As graphically illustrated in FIG. 3, the generated artifacts and key attributes are transmitted to the logic module, wherein the node monitoring unit interacts with the logic module via the respective program interface API. In its turn, the logic module is configured to receive the generated artifacts and key attributes and to transmit the generated attributes to the respective node of the IPFS file system for recording the generated artifacts to the file system. In response to receiving each generated artifact, the IPFS file system node generates a corresponding hash and transmits it back to the system logic module. The logic module is also configured to receive each generated hash and combine each generated hash with corresponding earlier received key attributes. Result of said combination is transmitted from the logic module to the blockchain platform node for recording in the blockchain platform. Thus, one block of the blockchain platform stores a hash that unambiguously identifies the respective artifact recorded in the IPFS file system, and key attributes which briefly describe this recorded artifact to enable quick filtering and search for necessary blocks in the blockchain platform without accessing the IPFS file system. Appropriate identification data of a given operation or particularly the event of issuance of a product certificate which identifies a respective block stored in the blockchain platform may be recorded as a key attribute, without accessing the IPFS file system for viewing the respective recorded artifact.

A particular example of implementation of the system for recording data in a metalworking enterprise. Three enterprise management information systems are deployed in the metalworking industry enterprise: an ERP system, a MES system, and a SCADA, wherein these systems are interconnected. The ERP system generates a manufacturing order, based on which this system generates a production task, which consists of a manufacturing technology and specifications. All generated production tasks are then combined into a production plan and uploaded to the MES system.

Execution of a production task is launched in the MES system, and all accompanying process parameters are recorded in the process of its execution. The MES system obtains data from the SCADA and records them being broken down by production tasks. Then data from the SCADA are connected to data concerning the execution of the production task recorded in the MES system, and all interconnected data are returned to the ERP system in the form of a fact of production task execution and process data accompanying the execution of the production task. The obtained data are analyzed by a node monitoring unit which extracts the necessary data in accordance with the industry standards and generates appropriate artifacts. The generated artifacts are recorded in the IPFS file system node by means of a system logic module, then they are combined into blocks and transmitted for further storage into the blockchain platform node. For example, if “loading” operation has been launched, as a rule, there is a plan specification for initial raw material. Besides the plan specification, the resulting data includes a factual specification which specifies weight and names of raw materials, loading time, process data, consumption of utilities, furnace operation modes, and personnel information. Composition and types of data to be placed in the IPFS file system and, thus, in the blockchain platform via a hash generated by this file system as mentioned above, are defined, in the first place, in accordance with the requirements of certification of specific products, i.e., with the necessary industry standards.

Part of the resulting data may then be used to generate a product certificate, and part may be used for analytic processing. The collected artifacts may be first encrypted by the logic module and then published in the IPFS file system, which provides an appropriate hash, in the encrypted form. The node monitoring unit may also provide other identification data for the company, the order, order identifier, etc. (in particular, as the key attributes and/or additional artifacts) and to directly transmit them for storage into the blockchain platform with the respective hash that has been provided. Blocks stored in the blockchain platform are closed according to the rules of the blockchain platform being used, as mentioned above.

As the whole cycle up to the delivery of the order is passed, the system for recording data related to manufacture and sales of products according to the present invention records all data related to the execution of the order. Information recorded in the blocks may contain both identifying particulars of the issued certificate and the particulars of the production task. Particulars of the production task are used for “later” connection of the certificate with the manufacture, e.g., in “orderless” manufacture or when using materials (intermediate products) from production stocks. When a certificate is generated, all blocks which contain data concerning the order are identified, data are extracted (and may be additionally verified), and a certificate is generated, which is stored in the blockchain platform as a separate record.

Next, enterprises that participate in the process of manufacture and sales of products (participants of the added value chain) operate in a similar manner, but according to their own technological cycles (wholesalers, distributors, manufacturers, etc.). When generating their own data, they create links to original certificates which have already been generated by preceding enterprises that participate in the process of manufacture and sales of products, and also collect all data generated in the process of their operation into blocks to be recorded in the IPFS file system via their system node, while the respective hash and key attributes are stored in the blockchain platform, and then also generate their own certificates based on the original ones.

Thus, the present invention ensures transparency when a product passes all stages of manufacture and sales up to the end user, warrants the validity of generated product certificates, enables revealing mala fide suppliers—“counterfeiters”. The present system for recording data related to manufacture and sales of products makes it possible to arrange comprehensive certification of manufacture and any other operations performed in respect of the manufactured product, with an adjustable level of details. Besides, the warranted transparency of manufacturing processes makes it possible to audit the fulfillment of industry standards, which should be checked for certification, substantially in real time.

Persons skilled in the art shall understand that, as and when necessary, the number of system structure elements or components may change. Besides, persons skilled in the art shall understand that the arrangement of system modules as shown is exemplary and, as and when necessary, it may be modified to achieve higher efficiency in specific applications. All possible different arrangements of the above-mentioned structural elements of the system are intended to be encompassed by the scope of protection of the present invention.

While the present specification shows exemplary implementations of the invention, it should be understood that various changes and modifications may be made without going beyond the scope of protection of the present invention which is defined by the appended claims. Functions, steps and/or operations recited in method claims in accordance with implementations of the present invention described herein should not necessarily be performed in a certain order unless otherwise noted or specified. Besides, system elements recited in singular do not rule out the possibility of using a plurality of such elements unless otherwise expressly specified.

1. A method for recording data, the method comprising:
recording first data related to manufacture and sales of products in one or more enterprise management information systems at a rate at which production cycles are completed, the first data as recorded being recorded data;
deriving, from the recorded data, second data in accordance with requirements of industry standards used in the enterprise, the second data as derived being derived data, and generating artifacts based on the derived data;
generating key attributes which briefly describe the artifacts;
transmitting the artifacts and the key attributes to a logic module;
transmitting the artifacts to a node of an interplanetary file system (IPFS) for recording in the IPFS;
generating, by the node of the IPFS, a hash for each of the artifacts as recorded in the IPFS, wherein the hash unambiguously identifies a respective artifact as recorded, and transmitting hashes generated for respective artifacts to the logic module;
combining, by the logic module, each generated hash with respective key attributes forming a combined result; and
transmitting the combined result to a blockchain platform node to be recorded in the blockchain platform.

2. The method of claim 1, further comprising providing access to the blockchain platform to users, wherein each of the users has an individual access level.

3. The method of claim 2, wherein the users are supervising or certifying agencies, wherein the individual access level for supervising or certifying agencies includes read-only access without possibility of making changes.

4. The method of claim 2, wherein the users are enterprises that participate in the manufacture and sales of products, wherein the individual access level for the enterprises includes full access.

5. The method of claim 1, further comprising:
generating additional artifacts based on data recorded in the one or more enterprise management information systems, wherein the additional artifacts relate to general manufacturing data; and
transmitting the additional artifacts to the logic module to be further recorded similarly to the generated artifacts.

6. The method of claim 1, further comprising generating a product certificate based on artifacts recorded in the IPFS by performing access to respective hashes recorded in the blockchain platform based on the key attributes.

7. A system to record data, the system comprising a plurality of nodes deployed in each enterprise that participates in manufacture and sales of products, wherein each of the plurality of nodes comprises:
one or more enterprise management information systems configured to record first data related to the manufacture and sales of products at a rate at which production cycles are completed, the first data as recorded being recorded data;
a node monitoring unit configured to derive, from the recorded data in one or more enterprise management information systems, second data in accordance with requirements of industry standards used in the enterprise, the second data as derived being derived data, and generate artifacts based on the derived data, and key attributes which briefly describe the artifacts;
a logic module configured to receive the artifacts and the key attributes from the node monitoring unit;
an interplanetary file system node of an interplanetary file system (IPFS) configured to receive the artifacts obtained from the logic module for recording in the IPFS and generating a hash for each of the artifacts as recorded in the IPFS, wherein the hash unambiguously identifies a respective artifact as recorded, and transmit hashes generated for respective artifacts to the logic module, wherein the logic module is further configured to combine each generated hash with respective key attributes forming a combined result; and
a blockchain platform node configured to receive the combined result to be recorded in the blockchain platform.

8. The system of claim 7, wherein the one or more enterprise management information systems are one or more of an enterprise resource planning (ERP) system, manufacturing execution system (MES), supervisory control and data acquisition (SCADA) system, or electronic document management system (EDMS).

9. The system of claim 7, wherein the node monitoring unit is further configured to generate additional artifacts based on data recorded in the one or more enterprise management information systems, wherein the additional artifacts relate to general manufacturing data, and to transmit the additional artifacts to the logic module to be further recorded similarly to the generated artifacts.

10. The system of claim 7, wherein the blockchain platform node is further configured to generate a product certificate on the basis of artifacts recorded in the IPFS file by performing access to respective hashes recorded in the blockchain platform based on of the key attributes.
